(19) United States
(12) Patent Application Publication
(10) Pub. No.: US 2025/0288113 A1
(43) Pub. Date: Sep. 18, 2025

(54) ADJUSTABLE CHAIR FOR POST-SURGICAL RECOVERY

(71) Applicant: Shakira Charlery, Lawrenceville, GA (US)

(72) Inventor: Shakira Charlery, Lawrenceville, GA (US)

(21) Appl. No.: 19/078,702

(22) Filed: Mar. 13, 2025

Related U.S. Application Data
(60) Provisional application No. 63/564,614, filed on Mar. 13, 2024.

(51) Int. Cl. A47C 7/02; A47C 1/032; A47C 1/0355; A47C 7/40; A47C 31/00

(52) U.S. Cl. CPC A47C 7/021; A47C 7/402; A47C 1/03211; A47C 1/03233; A47C 1/0355; A47C 31/008

(57) ABSTRACT

Disclosed is an adjustable chair for use during post-surgical recovery, including a seat with an opening adapted to reduce or eliminate pressure on the buttocks and hips when a user is seated.

### CROSS-REFERENCE TO RELATED APPLICATION(S)

This application claims the benefit of U.S. Provisional Application Ser. No. 63/564,614, filed on Mar. 13, 2024, the entirety of which is incorporated herein by reference.

### TECHNICAL FIELD

This disclosure relates to implementations of an adjustable chair for post-surgical recovery.

### BACKGROUND

Surgical procedures on the lower rear side of the trunk, such as Brazilian Butt Lifts using fat grafting, gluteoplasty with implants, liposuction, and other similar procedures, require patients to avoid placing pressure on their gluteal and lower trunk areas during recovery. After these procedures, it is typically recommended that patients refrain from sitting, lying, or applying pressure to these sensitive areas for a period of at least several weeks to prevent adverse effects on surgical results and the recovery process. The typical post-surgical period can be extremely uncomfortable and challenging, as the patient must find ways to rest without putting pressure on their lower trunk and gluteal areas.

Accordingly, there is a need for the adjustable chair disclosed herein. The present invention is directed to providing an adjustable chair configured to address these and other needs.

### SUMMARY OF THE INVENTION

It is to be understood that this summary is not an extensive overview of the disclosure. This summary is exemplary and not restrictive, and it is intended neither to identify key or critical elements of the disclosure nor delineate the scope thereof. The sole purpose of this summary is to explain and exemplify certain concepts of the disclosure as an introduction to the following complete and extensive detailed description.

Disclosed is an adjustable chair for use during post-surgical recovery, including a seat with an opening adapted to reduce or eliminate pressure on the buttocks and hips when a user is seated. This feature is particularly beneficial after surgical procedures on the buttocks, such as a Brazilian Butt Lift.

An example adjustable chair comprises a seat having an opening therein, one or more cushions removably positioned within the opening, a backrest that is vertically adjustable relative to the seat, and a footrest. When one or more of the cushions are removed from the opening, the seat supports the thighs of a user while allowing the user's buttocks and hips to extend downwardly through the opening. Additionally, vertical adjustment of the backrest modifies an effective dimension of the opening available to the user.

Another example adjustable chair comprises a seat having an opening therein and a thigh cushion, a cushion removably positioned within the opening, a backrest, and a footrest. When the cushion is removed from the opening, the thigh cushion of the seat supports the thighs of a user while allowing the user's buttocks and hips to extend downwardly through the opening. Additionally, the thigh cushion is horizontally adjustable relative to the backrest, and horizontal adjustment of the thigh cushion modifies an effective dimension of the opening available to the user.

### BRIEF DESCRIPTION OF THE DRAWINGS

FIG. 1 is a perspective view of an adjustable chair according to the principles of the present disclosure.

FIG. 2 is a perspective view of the adjustable chair shown in FIG. 1, with the cushions removed from the opening in the seat.

FIG. 3 is a perspective view of the adjustable chair shown in FIG. 1, with the backrest in a vertically adjusted position. Directional arrows illustrate the directions of vertical adjustment for the backrest.

FIG. 4 is a perspective view of the adjustable chair shown in FIG. 2, with the backrest in a reclined position and the footrest in an open-extended position.

FIG. 5A is an enlarged view of the area indicated by the broken line circle shown in FIG. 2.

FIG. 5B is an enlarged view of the area indicated by the broken line circle shown in FIG. 3, with directional arrows illustrating the directions of rotation for the adjustment knob.

FIG. 6 is an exploded view of the backrest of the adjustable chair shown in FIG. 1, showing the sliding frame assembly, cushioned surface, and cover.

FIG. 7 is a perspective view of the sliding frame assembly shown in FIG. 6.

FIG. 8 is a cutaway view of the sliding frame assembly, taken along lines 8-8 in FIG. 7.

FIG. 9 is an exploded view of the sliding frame assembly shown in FIG. 7, showing the support frame and sliding frame separated.

FIG. 10 is another exploded view of the sliding frame assembly shown in FIG. 7.

FIG. 11 is a perspective view of another adjustable chair according to the principles of the present disclosure.

FIG. 12 is a perspective view of the adjustable chair shown in FIG. 11, with the cushion removed from the opening in the seat.

FIG. 13 is a perspective view of the adjustable chair shown in FIG. 12, with the backrest in a vertically adjusted position. Directional arrows illustrate the directions of vertical adjustment for the backrest and horizontal adjustment for the thigh cushion.

FIG. 14 is a perspective view of the adjustable chair shown in FIG. 13, with the backrest in a reclined position and the footrest in an open-extended position.

FIG. 15 is an exploded view of the sliding frame assembly of the backrest on the adjustable chair shown in FIG. 11, showing the support frame and sliding frame separated.

FIG. 16 is another perspective view of the support frame and sliding frame shown in FIG. 15.

FIG. 17 is a perspective view of the sliding rail assembly of the thigh cushion on the adjustable chair shown in FIG. 11.

Like reference numerals refer to corresponding parts throughout the several views of the drawings.

### DETAILED DESCRIPTION

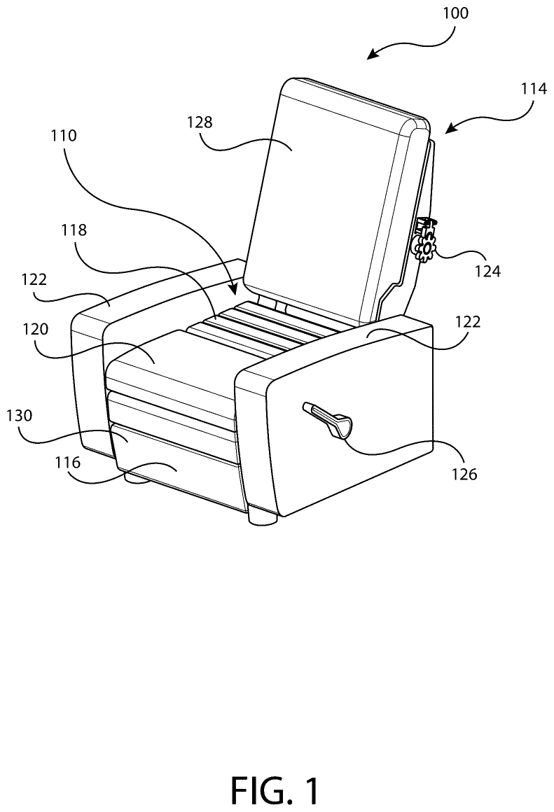

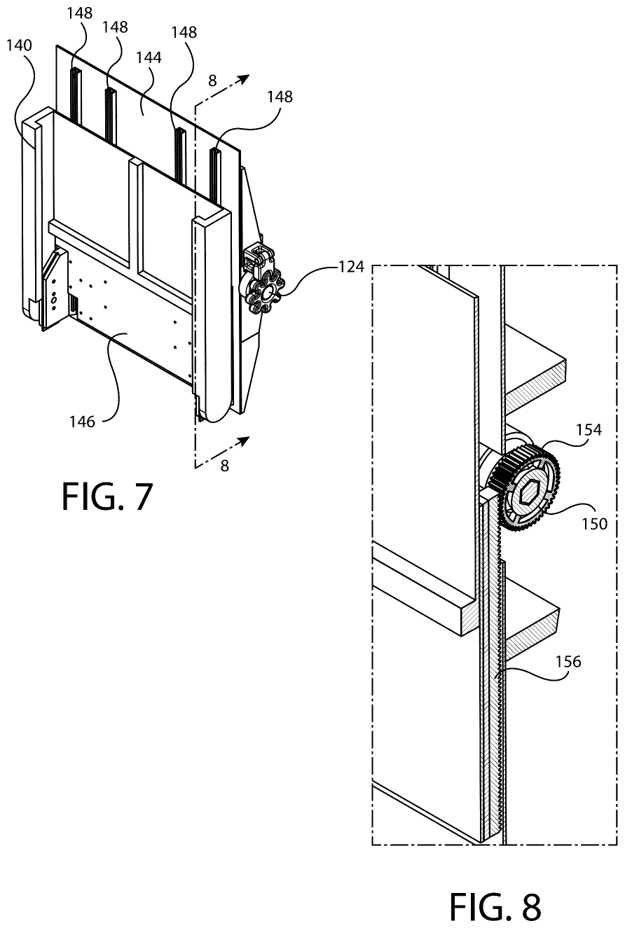

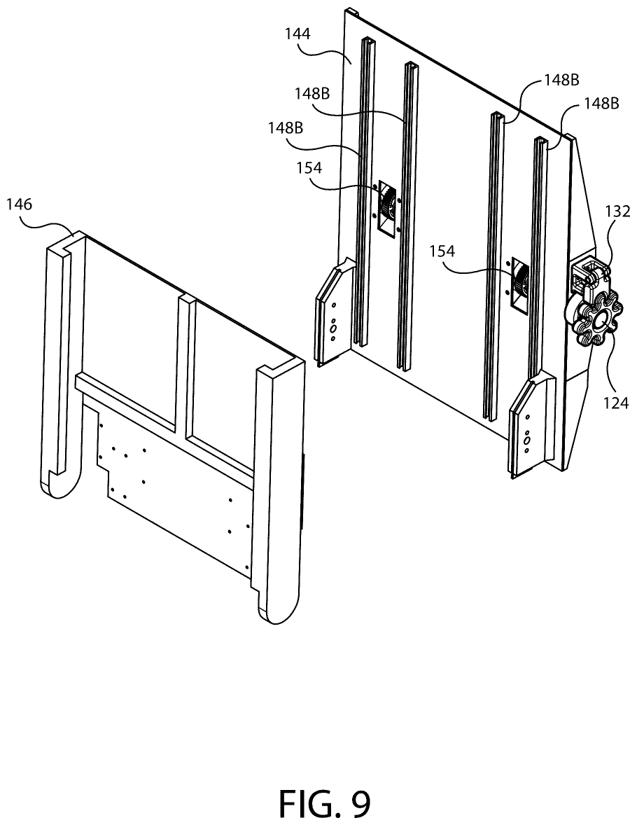

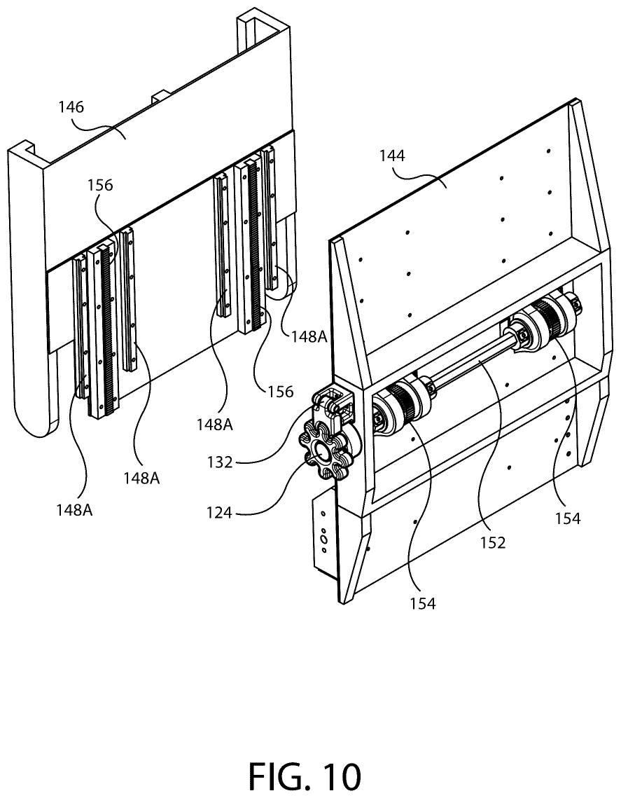

FIGS. 1-10 illustrate an example adjustable chair 100 according to the principles of the present disclosure. The adjustable chair 100 includes a seat with an opening adapted to reduce or eliminate pressure on the buttocks and hips when a user is seated. This feature is particularly beneficial for recovery from surgical procedures on the buttocks, such as a Brazilian Butt Lift.

In one implementation, the adjustable chair 100 comprises a seat 110 having an opening 112 therein, a vertically adjustable backrest 114, and a footrest 116. The seat 110 includes one or more cushions 118 removably positioned within the opening 112. When one or more of the cushions 118 are removed, the seat 110 is configured to support the thighs of a seated user while allowing the user's buttocks and hips to extend downwardly into the opening 112, thereby alleviating pressure on the buttocks and hips. Furthermore, the backrest 114 is vertically adjustable relative to the seat 110. Vertical adjustment of the backrest 114 modifies an effective dimension of the opening 112 in the seat 110. In this manner, the opening 112 in the adjustable chair 100 can be adapted to meet the comfort and ergonomic requirements of various users.

The seat 110 includes a thigh cushion 120 and removable cushions 118, and is positioned between two armrests 122. As shown, there are four removable cushions 118, each of which can be individually removed from the opening 112 in the seat 110. The opening 112 is defined between the thigh cushion 120 and the backrest 114 of the adjustable chair 100. Removing one or more of the cushions 118 modifies an effective dimension of the opening 112. When one or more cushions 118 are removed, the seat 110 is configured to alleviate pressure on the buttocks and hips by redirecting pressure to the thigh area of a seated user.

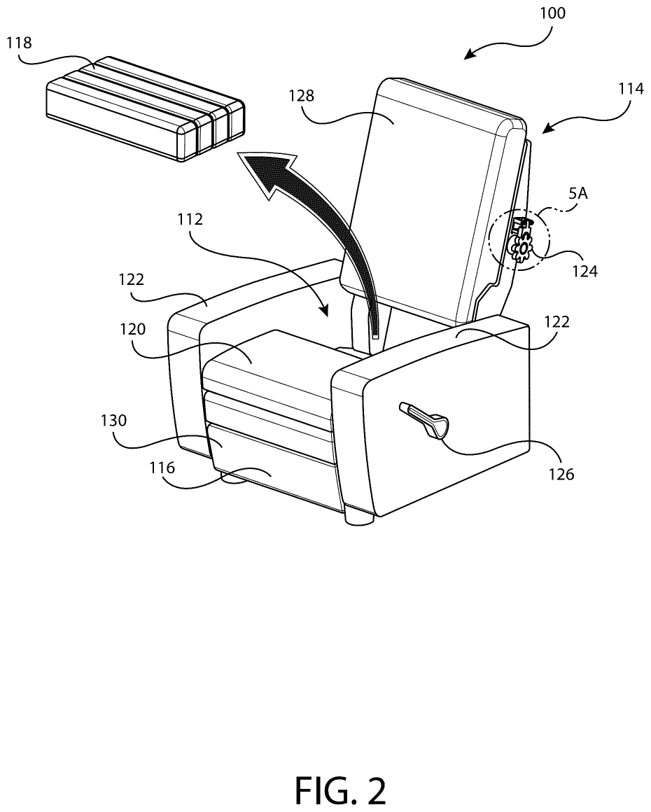

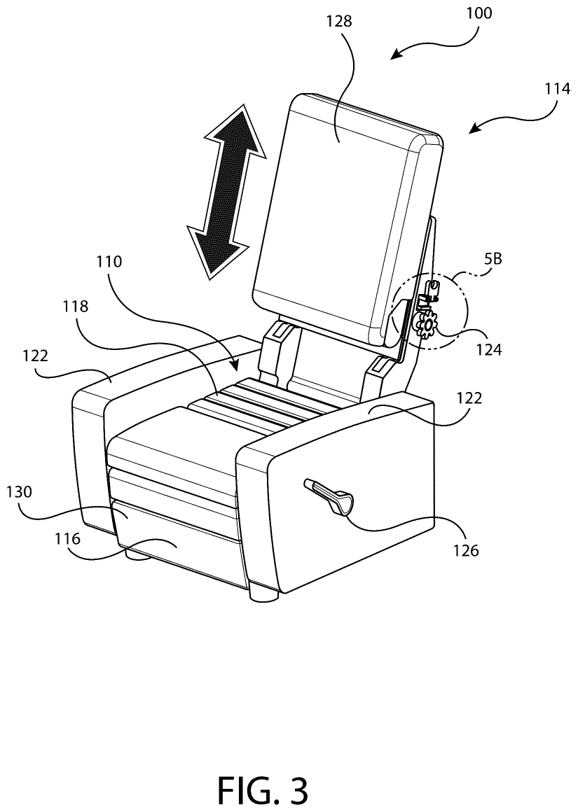

The backrest 114 includes a cushioned surface 128 configured to support the back and shoulders of a user while seated in the adjustable chair 100. The backrest 114 is operably connected to an adjustment knob 124 positioned on a side of the backrest 114. However, in other implementations, the adjustment knob 124 may be positioned elsewhere on the adjustable chair 100. The adjustment knob 124, in conjunction with an adjustment mechanism, is configured to vertically adjust the backrest 114 relative to the seat 110. The adjustment knob 124 is configured such that the direction of rotation (clockwise or counterclockwise) determines the direction of vertical displacement. FIG. 2 illustrates the backrest 114 in its initial, unadjusted position; FIG. 3 illustrates the backrest 114 in a vertically adjusted position.

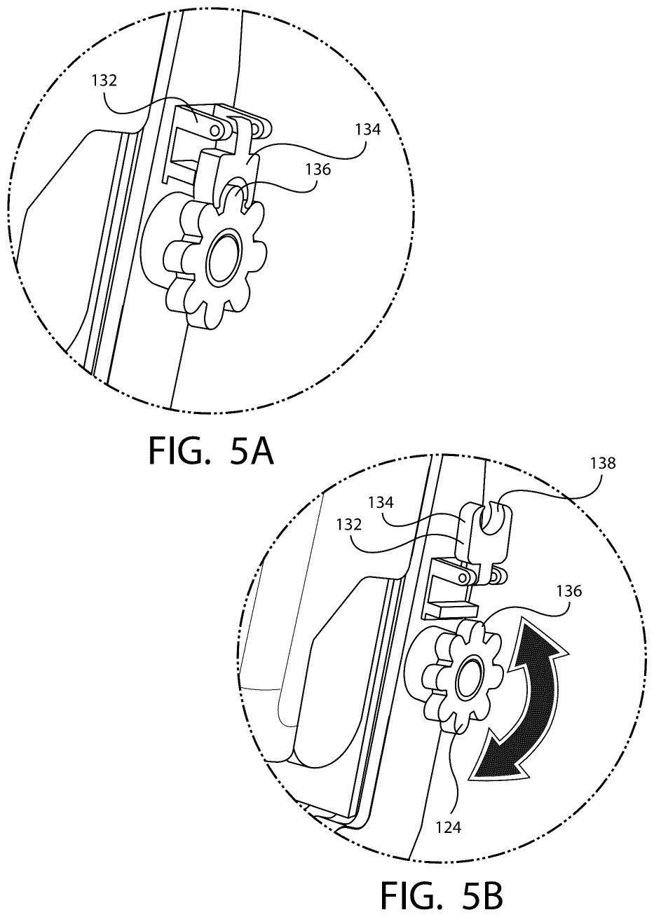

In some implementations, the adjustable chair 100 includes a stop mechanism 132 configured to selectively prevent rotation of the adjustment knob 124. The arm 134 of the stop mechanism 132 is configured to receive one of the lugs 136 arranged in a radial pattern around the perimeter of the adjustment knob 124, thereby preventing rotation. The stop mechanism 132 pivots between a first position, where an opening 138 at the distal end of the arm 134 engages one of the lugs 136 (see, e.g., FIG. 5A), and a second position, where the arm 134 is disengaged from the lug 136 (see, e.g., FIG. 5B).

A mechanism other than the stop mechanism 132 disclosed herein may be used to selectively prevent rotation of the adjustment knob 124.

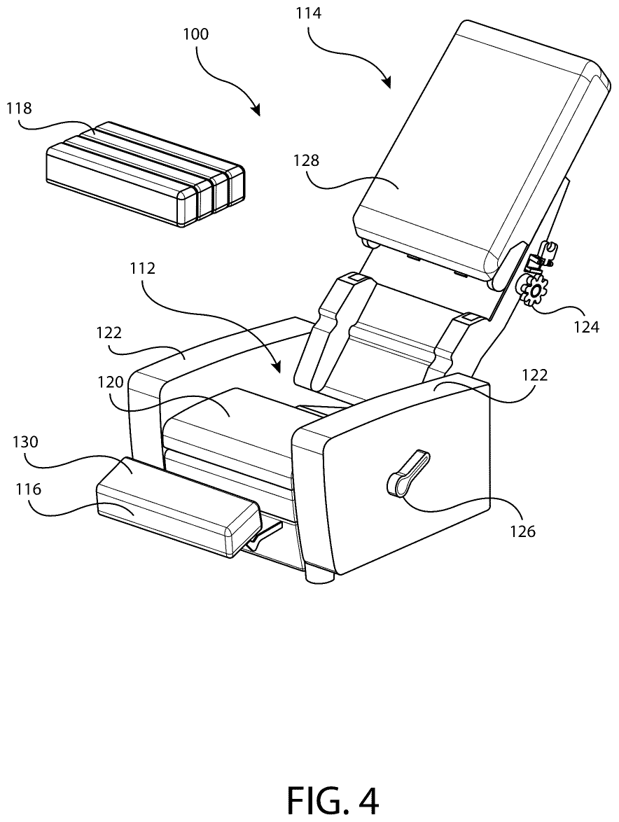

In addition to being vertically adjustable, the backrest 114 is adjustable from an erect position (see, e.g., FIG. 3) to a reclined position (see, e.g., FIG. 4). The adjustable chair 100 includes an adjustment lever 126 operably connected to the backrest 114. The adjustment lever 126, working in conjunction with a reclining mechanism, is configured to adjust the reclining angle of the backrest 114, enabling the backrest 114 to transition between erect and reclined positions. Although a specific reclining mechanism is not disclosed, it is understood that one of ordinary skill in the art would be capable of selecting a suitable mechanism for this purpose.

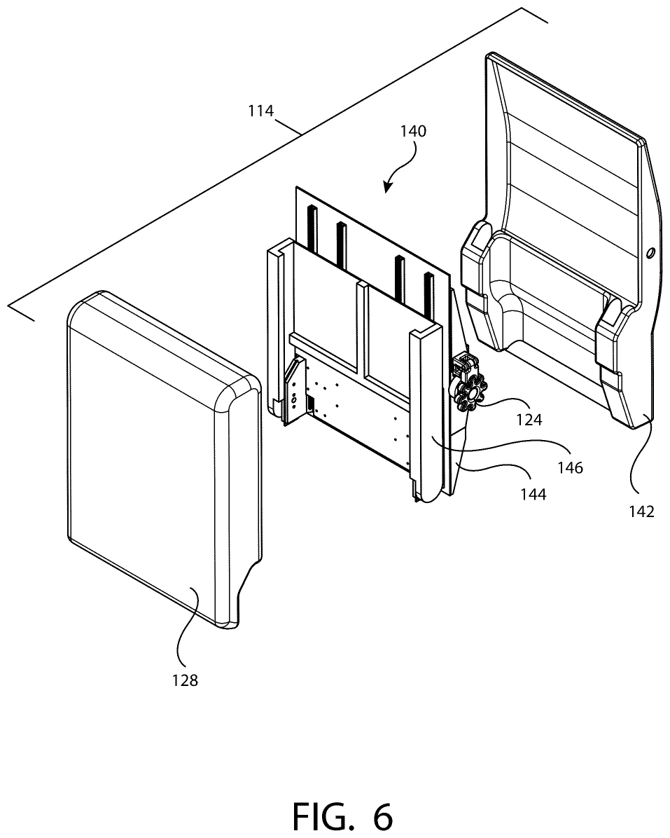

As shown best in FIG. 6, the backrest 114 comprises a sliding frame assembly 140, the cushioned surface 128, and a cover 142 enclosing the rear of the backrest 114.

The sliding frame assembly 140 is an example of an adjustment mechanism that can be used in conjunction with the adjustment knob 124 to vertically adjust the backrest 114. The sliding frame assembly 140 comprises a support frame 144 and a sliding frame 146. The support frame 144 is pivotally connected to the base of the adjustable chair 100, allowing the backrest 114 to recline as described above. The sliding frame 146 is slidably connected to the support frame 144 by several dovetail slides 148 and a linear actuator 150. Each dovetail slide 148 comprises a dovetail guide 148A and a dovetail slot 148B. The example linear actuator 150 includes two rack-and-pinion mechanisms, operably connected to the adjustment knob 124 by an axle 152. Rotation of the adjustment knob 124 drives the rotation of two circular gears 154, each of which engages a linear gear 156 on the backside of the sliding frame 146. The cushioned surface 128 is attached to the front of the sliding frame 146, and the cover 142 encloses the back of the support frame 144.

The footrest 116 includes a cushioned surface 130 configured to support the lower legs and feet of a user while seated in the adjustable chair 100. The footrest 116 is configured to automatically extend when the backrest 114 is reclined (see, e.g., FIG. 4). The footrest 116 is operably connected to the adjustment lever 126, preferably via a linkage mechanism that may be connected to the reclining mechanism. Consequently, as the backrest 114 transitions from the erect position to a reclined position, the footrest 116 simultaneously moves from a closed position (see, e.g., FIG. 3) to an open-extended position (see, e.g., FIG. 4).

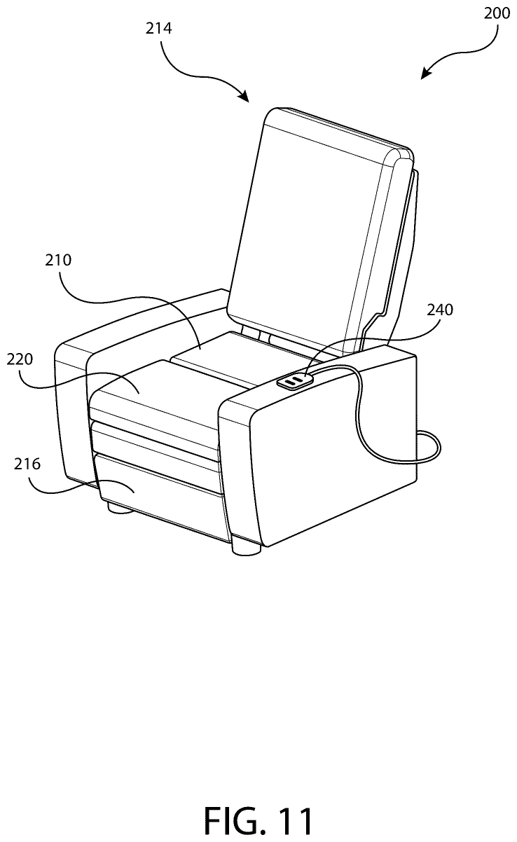

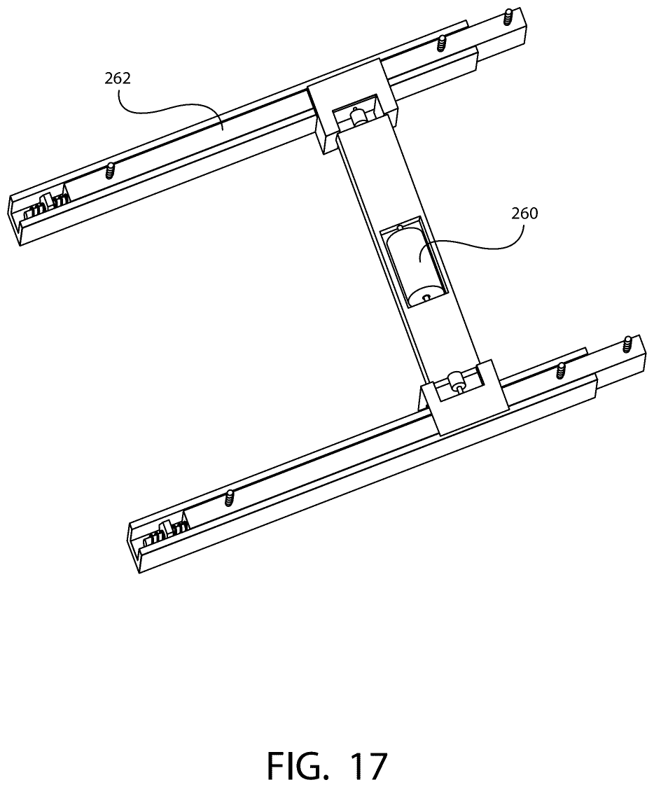

FIGS. 11-17 illustrate another example adjustable chair 200 according to the principles of the present disclosure. The adjustable chair 200 is similar to the adjustable chair 100 discussed above but includes a remote control 241 and an electric motor 249 that drives the linear actuator 250 of the backrest 214. The remote control 241, in conjunction with the electric motor 249, is configured to replace and replicate the functionality of the adjustment knob 124 and, in some implementations, the adjustment lever 126. Furthermore, the thigh cushion 220 of the seat 210 is horizontally adjustable relative to the backrest 214 to also modify an effective dimension of the opening 212 in the seat 210.

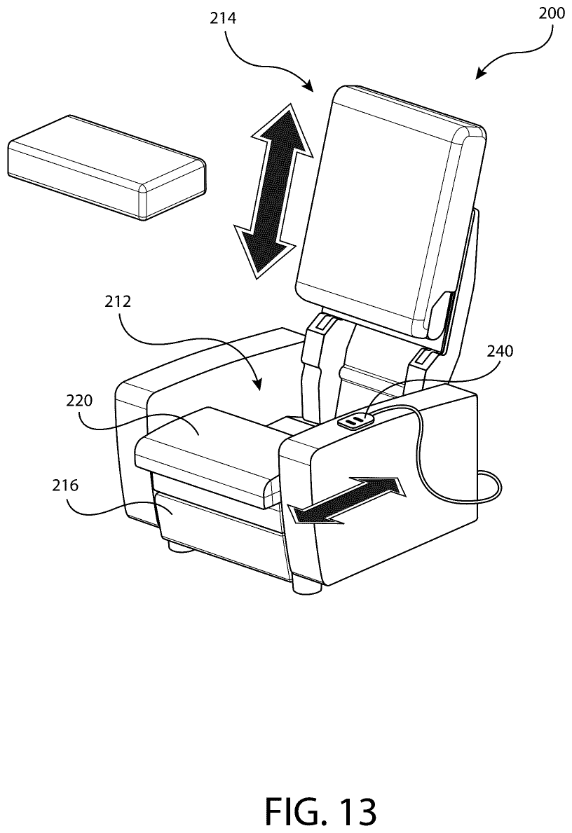

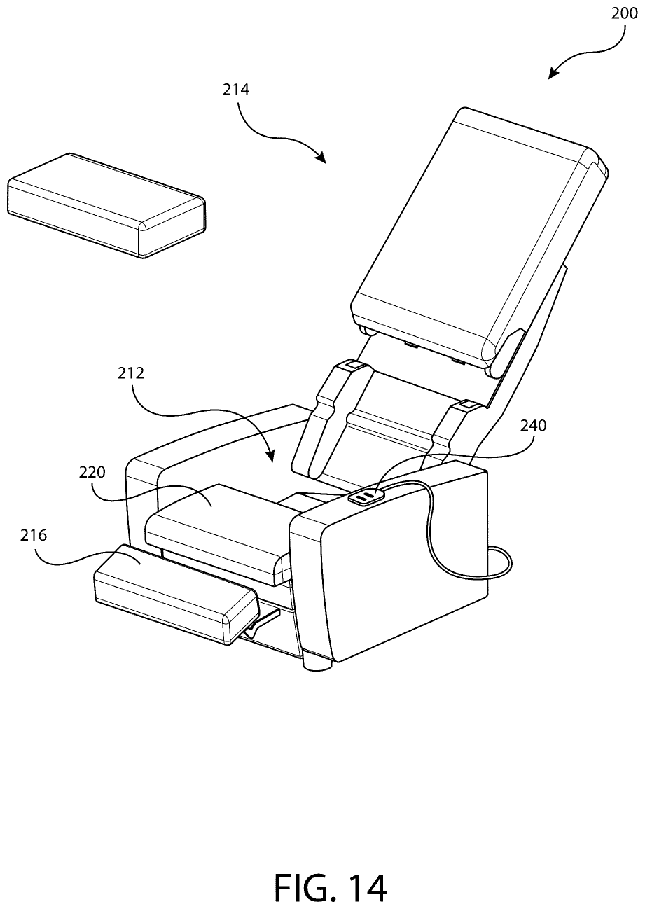

In the preferred implementation, the remote control 241, in conjunction with the electric motor 249, is configured to facilitate multiple adjustments of the adjustable chair 200. The remote control 241 and the electric motor 249 are configured to adjust the vertical position of the backrest 214 relative to the seat 210 and, in some implementations, to move the backrest between an erect position (see, e.g., FIG. 13) and a reclined position (see, e.g., FIG. 14). Additionally, the remote control 241, in conjunction with the electric motor 249 and a linkage (not shown), or with a separate electric motor (not shown), is configured to move the footrest 216 between a closed position (see, e.g., FIG. 13) and an open-extended position (see, e.g., FIG. 14).

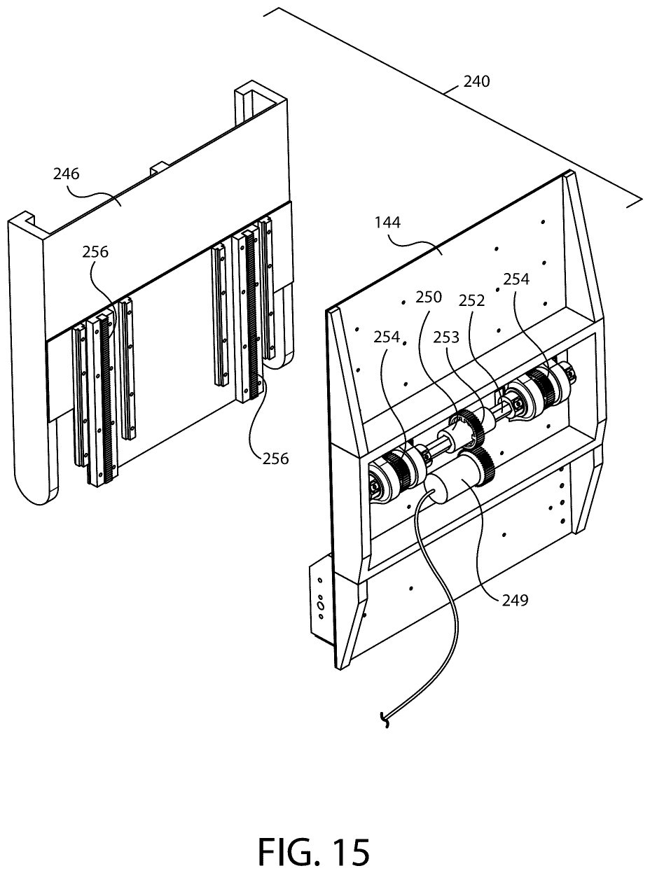

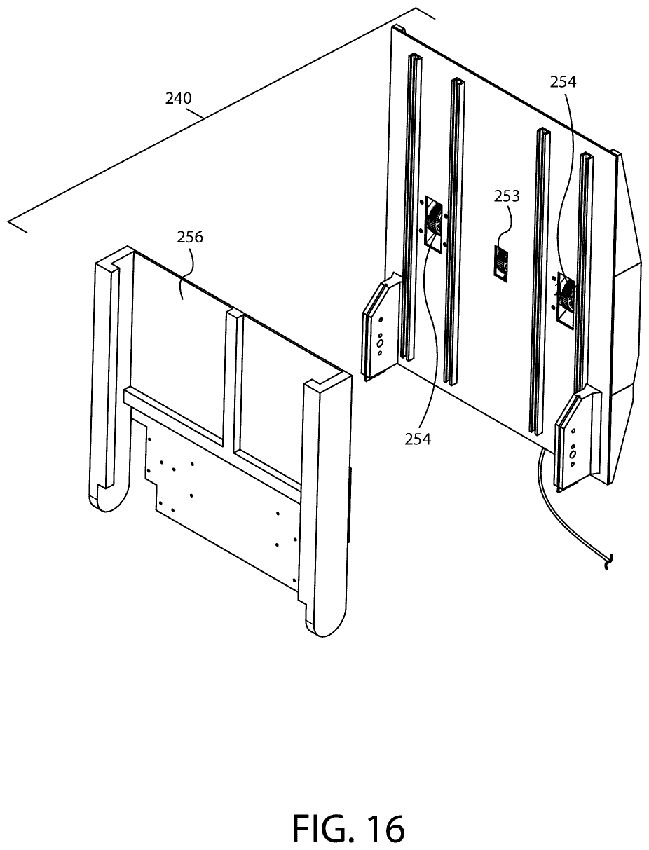

As shown best in FIG. 15, the electric motor 249 is operably connected to the linear actuator 250 of the sliding frame assembly 240. More specifically, the linear actuator 250 includes a circular gear 253 that is joined to the axle 252 by, for example, a keyed joint. In this way, rotation of the electric motor 249 drives rotation of the axle 252 and thereby the other circular gears 254 of the linear actuator 250 that engage with the linear gears 256 on the back side of the sliding frame 246. This arrangement of components, in conjunction with the remote control 241, facilitates vertical adjustment of the backrest 214.

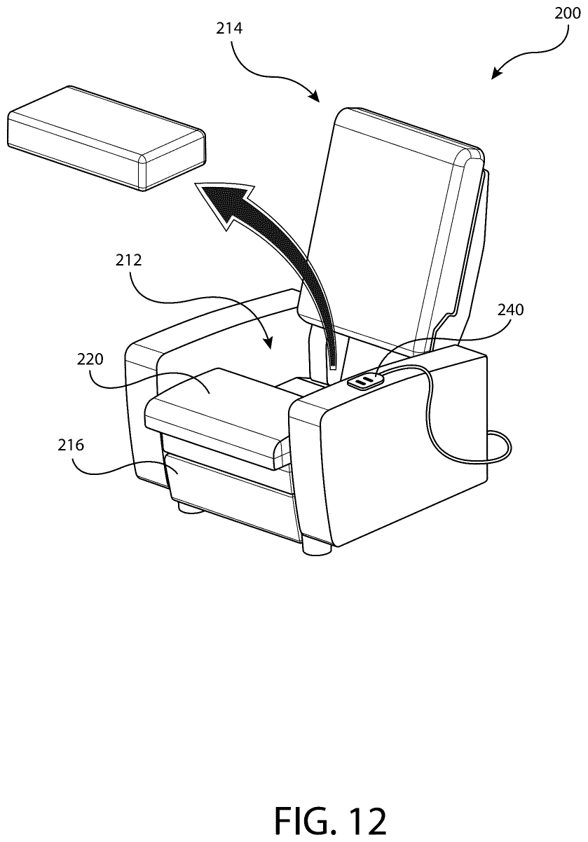

The thigh cushion 220 of the seat 210 is operably connected to the remote control 241 and an electric motor 260. The remote control 241, working in conjunction with the electric motor 260, is configured to horizontally adjust the thigh cushion 220 relative to the backrest 214. FIG. 11 illustrates the thigh cushion 220 in its initial, unadjusted position; FIG. 12 illustrates the thigh cushion 220 in a horizontally adjusted position. The thigh cushion 220 rides on a sliding rail assembly 262 positioned in the base of the adjustable chair 200. The sliding rail assembly 262 is operably connected to the onboard electric motor 260, which drives the horizontal movement of the sliding rail assembly 262 and, thereby, the thigh cushion 220.

Although not shown in the drawings, it is understood that suitable wiring connects the electrical components of the adjustable chair 200 disclosed herein.

The foregoing description of the invention is intended to be illustrative; it is not intended to be exhaustive or to limit the claims to the precise forms disclosed. Those skilled in the relevant art can appreciate that many modifications and variations are possible in light of the foregoing description and associated drawings.

Reference throughout this specification to an “embodiment” or “implementation” or words of similar import means that a particular described feature, structure, or characteristic is included in at least one embodiment of the present invention. Thus, the phrase “in some implementations” or a phrase of similar import in various places throughout this specification does not necessarily refer to the same embodiment.

The described features, structures, or characteristics may be combined in any suitable manner in one or more embodiments. In the above description, numerous specific details are provided for a thorough understanding of embodiments of the invention. One skilled in the relevant art will recognize, however, that embodiments of the invention can be practiced without one or more of the specific details, or with other methods, components, materials, etc. In other instances, well-known structures, materials, or operations may not be shown or described in detail.

1. An adjustable chair comprising:
a seat having an opening therein;
one or more cushions removably positioned within the opening;
a backrest that is vertically adjustable relative to the seat; and
a footrest;
wherein, when one or more cushions are removed from the opening, the seat supports thighs of a user while allowing the user's buttocks and hips to extend downwardly through the opening; and
wherein vertical adjustment of the backrest modifies an effective dimension of the opening available to the user.

2. The adjustable chair of claim 1, further comprising two armrests; wherein the seat includes a thigh cushion positioned between the two armrests; and wherein the opening is defined by the thigh cushion, the backrest, and the two armrests.

3. The adjustable chair of claim 2, wherein the thigh cushion is horizontally adjustable relative to the backrest, and wherein horizontal adjustment of the thigh cushion also modifies an effective dimension of the opening available to the user.

4. An adjustable chair comprising:
a seat having an opening therein and a thigh cushion;
a cushion removably positioned within the opening;
a backrest; and
a footrest;
wherein, when the cushion is removed from the opening, the thigh cushion of the seat supports thighs of a user while allowing the user's buttocks and hips to extend downwardly through the opening; and
wherein the thigh cushion is horizontally adjustable relative to the backrest, and horizontal adjustment of the thigh cushion modifies an effective dimension of the opening available to the user.

5. The adjustable chair of claim 4, further comprising two armrests; wherein the thigh cushion of the seat is positioned between the two armrests; and wherein the opening is defined by the thigh cushion, the backrest, and the two armrests.

6. The adjustable chair of claim 5, wherein the backrest is vertically adjustable relative to the seat, and wherein vertical adjustment of the backrest also modifies an effective dimension of the opening available to the user.
